(19) United States
(12) Patent Application Publication
(10) Pub. No.: US 2016/0011965 A1
(43) Pub. Date: Jan. 14, 2016

(54) PASS THROUGH STORAGE DEVICES

(71) Applicant: Seagate Technology LLC, Cupertino, CA (US)

(72) Inventors: Robert Dale Murphy, Longmont, CO (US); John Edward Moon, Superior, CO (US); Stanton Keeler, Longmont, CO (US); Richard Esten Bohn, Shakopee, MN (US)

(73) Assignee: Seagate Technology LLC, Cupertino, CA (US)

(21) Appl. No.: 14/028,528

(22) Filed: Sep. 16, 2013

Related U.S. Application Data
(60) Provisional application No. 61/790,978, filed on Mar. 15, 2013.

(51) Int. Cl. G06F 12/02

(52) U.S. Cl. CPC G06F 12/0246

(57) ABSTRACT

The disclosure is directed to apparatus and methods for implementing a pass through storage architecture that converts. Embodiments generally include a control circuit configured to allocate data among at least a first memory tier and a second memory tier. The first memory tier can include a solid state memory and the second memory tier can include a nonvolatile memory. In some embodiments, a pass-through storage device may be implemented. Embodiments may further include one or more interfaces configured to allow communication between the control circuit and one or more memories, devices, systems, or any combination thereof.

### CROSS REFERENCE TO RELATED APPLICATIONS

The present application claims priority to pending U.S. provisional patent application Ser. No. 61/790,978, filed Mar. 15, 2013, and entitled “Extended Capacity SSD Using Pass Through Tiered Storage Design”, the content of which is hereby incorporated by reference in its entirety.

### BACKGROUND

The present disclosure relates to data storage devices having a hybrid storage architecture with at least two distinct types of data storage media.

### SUMMARY

Embodiments disclosed herein generally provide apparatuses and methods for a pass through storage device. Some embodiments of an apparatus can include a control circuit configured to allocate data between at least a first memory tier and a second memory tier. The first memory tier may include a nonvolatile solid state memory and the second memory tier can include another nonvolatile memory. The apparatus may further include a host interface and a data storage device interface. The host interface may be configured to communicate between the control circuit and a host device. The data storage device interface may be configured to communicate between the control circuit and a data storage device that includes the second memory tier. The data storage device interface may mimic or replicate the host interface such that the data storage device interfaces with the apparatus as if the data storage device were interfacing directly with the host device. The control circuit may further be configured to manage transfer of data to a host device, the first memory tier, and the second memory tier.

Some embodiments provide an apparatus including a control circuit, an initiator interface, and a target interface. The control circuit may be configured to allocate data among at least a first memory tier and a second memory tier, the first memory tier including a nonvolatile solid state memory and the second memory tier including another nonvolatile memory. The initiator interface may be configured to communicate between the control circuit and an initiator device. The target interface may be configured to communicate between the control circuit and a target device. At least one of the initiator interface and the target interface may mimic a host controller such that a data storage device including the nonvolatile memory of the second memory tier interfaces with the apparatus as if it were interfacing with a host device.

Certain embodiments provide an apparatus including a control circuit configured to receive, from a host system, a request to write selected data. The control circuit may further be configured to cache the selected data to a first nonvolatile solid state memory. Further, the control circuit may store at least a subset of the selected data to a second nonvolatile memory based on a trigger event. The apparatus may further include a host interface and a data storage interface. The host interface may be configured to communicate between the control circuit and the host system. The data storage interface may be configured to communicate between the control circuit and the second nonvolatile memory. The data storage interface may mimic the host interface such that the data storage device interfaces with the apparatus as if the data storage device were interfacing directly with the host system.

### BRIEF DESCRIPTION OF THE DRAWINGS

FIG. 1 is a diagram of certain embodiments of a pass through storage device;

FIG. 2 is a functional block diagram of certain embodiments of a pass through storage device;

FIG. 3 is a functional block diagram of certain embodiments of a pass through storage device;

FIG. 4 is a flowchart of an certain embodiments of a method for pass through storage devices; and

FIG. 5 is a flowchart of certain embodiments of a method for pass through storage devices.

### DETAILED DESCRIPTION

In the following detailed description of the embodiments, reference is made to the accompanying drawings which form a part hereof, and in which are shown by way of illustration of specific embodiments. It is to be understood that features of the various described embodiments may be combined, other embodiments may be utilized, and structural changes may be made without departing from the scope of the present disclosure.

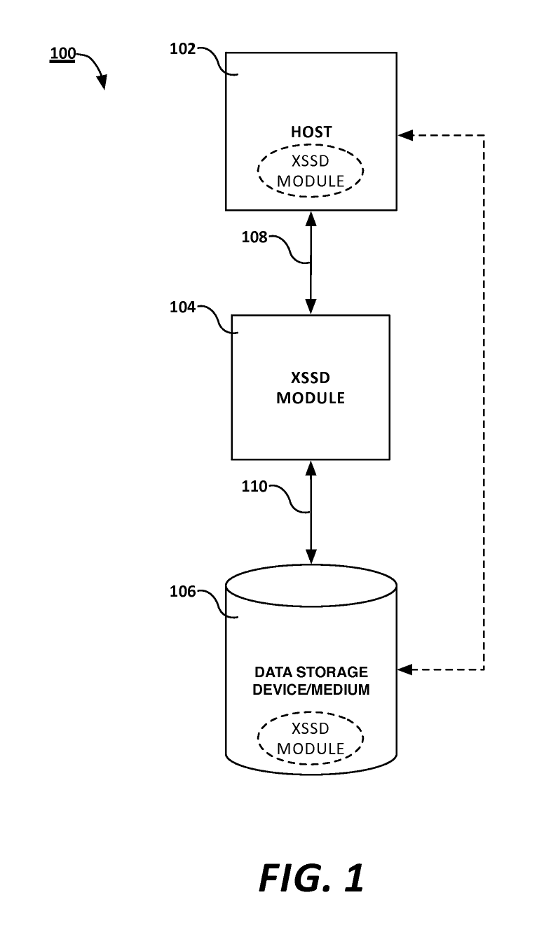

FIG. 1 shows a diagram a system 100 including an extended solid state device (XSSD) module 104, in accordance with some embodiments of the present invention. The system 100 may further include a host 102 and a data storage device (DSD) having a data storage medium (DSM) 106 (hereinafter referred to as DSM 106) which can be connected to the XSSD module 104.

The host 102 may also be referred to as the host system or host computer. The host 102 can be a desktop computer, a laptop computer, a server, a personal digital assistant (PDA), a telephone, a music player, another electronic device, or any combination thereof. The DSM 106 may be any of the devices listed above with respect to the host 102, or any other device which may be used to store or retrieve data, such as a hard disc drive (HDD).

In some embodiments, the XSSD module 104 can be integrated on a bridge adaptor configured to connect to and interface with the host 102 and the DSM 106. Alternatively or additionally, the XSSD module 104 can be integrated on the host 102 or the DSM 106.

The XSSD module 104 can communicate with the host 102 and the DSM 106 via one or more interfaces 108, 110 that may include a connector that allows the XSSD module 104 to be physically removed from the host 102, the DSM 106, or both. The interface(s) 108 may include hardware circuits, logic, firmware, or any combination thereof. In some embodiments, the interface(s) 108 comprise(s) an interface compliant to one or more of the following standards: universal serial bus (USB), IEEE 1394, serial advanced technology attachment (SATA), external SATA (eSATA), parallel advanced technology attachment (PATA), small computer system interface (SCSI), serial attached SCSI (SAS), peripheral component interconnect express (PCIe), and fiber channel (FC). However, any other interface suitable for allowing the XSSD module 104 to communicate with the host 102, the DSM 106, or both, may be used. The XSSD module 104, the DSM 106, or both, may be disposed internal or external to an enclosure of the host 102.

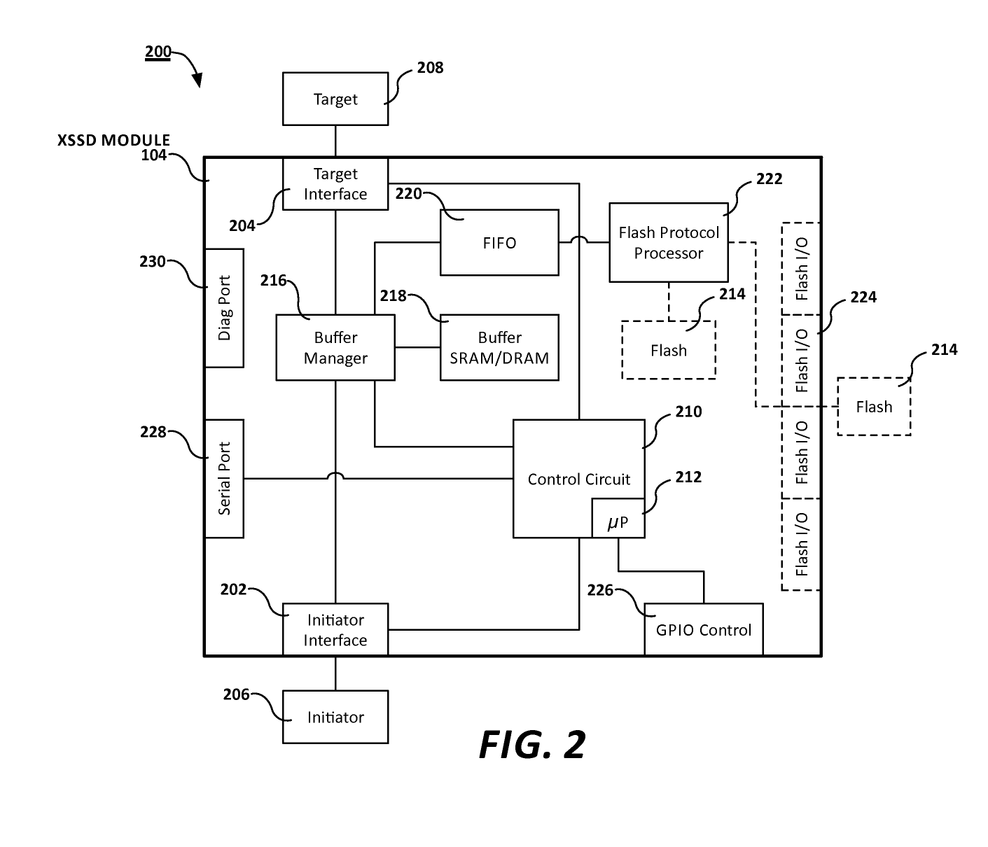

Referring to FIG. 2, a functional block diagram of an illustrative embodiment of a system 200 including an extended solid state module device (XSSD) module 104 is shown. The XSSD module 104 may include multiple ports to permit the connection of various devices thereto, such as, for example, one or more types of nonvolatile data storage media.

The XSSD module 104 may include an initiator interface 202 and a target interface 204. The initiator interface 202 can be configured to allow the XSSD module 104 to interface with an initiator 206, and the target interface 204 can be configured to allow the XSSD module 104 to communicate with a target 208. In some embodiments, the initiator 206 may be a host device, such as the types of devices described above with reference to the host 102 of FIG. 1. The target 208 may be a data storage device, such as the types of described above with reference to the DSM 106 of FIG. 1. In other embodiments, a data storage device may be considered an initiator 206 and a host device may be considered a target 208.

The XSSD module 104 can include a control circuit 210 having one or more associated processors 212. The control circuit 210 may be configured to control and execute a hybrid file system that tracks and determines assignment of data received from or requested by the initiator 206, the target 208, or both.

In some embodiments, the XSSD module 104 may include a solid state memory (SSM) 214 to be used, at least in part, as cache for data that meets one or more cache criteria. The SSM 214 can be volatile solid state memory (VSSM), such as static random-access memory (SRAM) or dynamic random-access memory (DRAM), or the SSM 214 can be nonvolatile solid state memory (NVSSM), such as flash memory. Although the following description refers primarily to NVSSM or flash memory 214, it should be understood that any other type(s) or combination(s) of SSM 214 or NVSSM may be used.

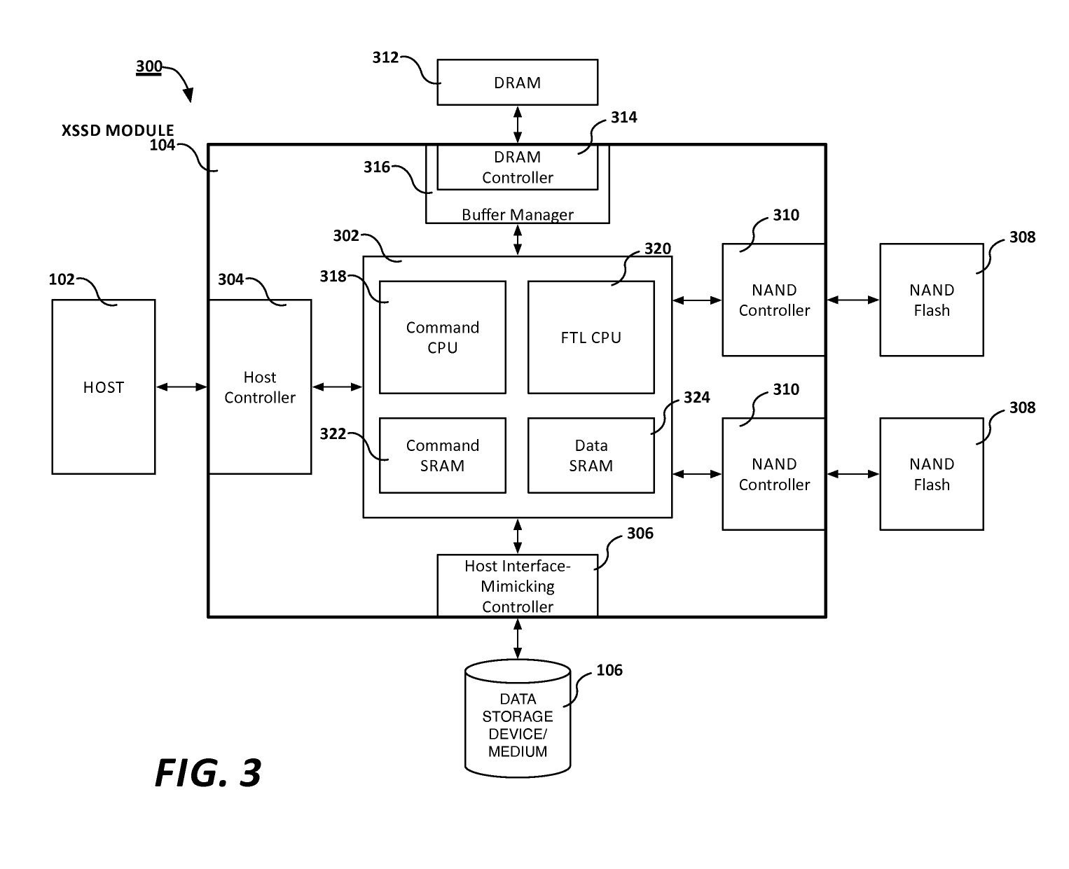

The XSSD module 104 may include a buffer manager 216 that can allocate data to/from one or more memory units used as buffer memory 218. For example, the XSSD module 104 may have one or more SRAM or DRAM units 218 that are used to temporarily store data transmitted during read and write operations to/from the initiator 206, to/from the target 208, to/from NVSSM, or any combination thereof. The buffer memory 218 may include a command queue (not shown) where access operations can be temporarily stored pending execution. Although the SRAM/DRAM unit(s) 218 are depicted in FIG. 2 as residing within the XSSD module 104, it should be understood that they may additionally or alternatively be disposed external to the XSSD module 104, such as, for example, the DRAM unit 312 shown in FIG. 3.

The XSSD module 104 further can include a first-in-first-out (FIFO) memory unit 220 and a flash protocol processor 222 communicatively coupling a flash memory 214 to the buffer manager 216, which, in turn, is communicatively coupled to the control circuit 210. The FIFO memory unit 220 may receive data from the buffer manager 216, and store the data until it is transmitted on a FIFO basis to the flash protocol processor 222. The FIFO memory unit 220 can include error correction code (ECC) to implement checks on data received at the FIFO memory unit 220 and correct any error bits such that integrity of the data is maintained.

The flash protocol processor 222 may be a specialized processor dedicated to extracting/processing/configuring data received from the FIFO memory unit 220 in accordance with one or more communication protocols such that the flash protocol processor 222 transmits the data in a format suitable for storage in the flash memory 214.

Alternatively or additionally, the XSSD module 104 may be configured to allow attachment of one or more external flash (or any other type of NVSSM) memory units 214. FIG. 2 depicts the capability of flash memory 214 being communicatively coupled to the flash protocol processor 222 via one or more flash input/output (I/O) ports 224. Although a single external flash memory 214 is shown, it should be understood that a plurality of external flash memory units 214 can be attached to the XSSD module 104.

The XSSD module 104 may further include a general purpose input/output (GPIO) control 226 that can control the behavior of a GPIO pin (not shown) on the XSSD module 104. Moreover, the XSSD module 104 may further include one or more additional ports suitable for connecting a device to be used in combination with the XSSD module 104. For example, the XSSD module 104 can include one or more serial ports 228 compliant to the RS-232 standard to interface with a modem or a similar communication device. As another example, the XXSD module 104 can include one or more diagnostic ports 230 to interface with, for example, a testing device that can be used to diagnose issues with the XSSD module 104.

FIG. 3 shows a functional block diagram of another illustrative embodiment of a system 300 including an extended solid state device (XSSD) module 104. The XSSD module 104 may include a controller 302, which, in some embodiments, is an example of the control circuit 210 described above with reference to FIG. 2.

The controller 302 may communicate with a host system 102 via an interface including a host controller 304. The controller 302 can also communicate with a data storage device (DSD) 106 via an interface 110 including a host interface-mimicking controller 306. The host interface-mimicking controller 306 is said to mimic because it can be configured to replicate the host controller 304 such that the DSD 106 interfaces with the XSSD module 104 as if it were interfacing directly with the host system 102, that is the DSD 106 cannot differentiate between interfacing with the XSSD module 104 and a host system 102.

The controller 302 may further communicate with one or more nonvolatile solid state memory (NVSSM) units 308 via one or more NVSSM controllers 310. In some embodiments, the NVSSM units 308 are NAND flash memory units and the NVSSM controllers 310 are NAND controllers. Further, the XSSD module 104 may use the NVSSM units 308 as non-volatile cache and use the DSD 106 as permanent storage. Accordingly, it should be understood that the XSSD module 104 may be configured to be coupled to and communicate with any type of memory suitable for use as a non-volatile cache and any type of memory suitable for use as permanent storage.

The controller 302 may further communicate with a buffer memory unit 312 via an interface including a buffer memory controller 314. In some embodiments, the buffer memory controller 314 may be a component of a buffer manager 316 used to allocate data to/from the buffer memory 312. The buffer memory unit 312 may be used to temporarily store data transmitted during read and write operations to/from the initiator 206, to/from the target 208, to/from the NVSSM, or any combination thereof. The buffer memory unit 312 may include a command queue (not shown) where access operations can be temporarily stored pending execution. Although the buffer memory unit 312 is depicted in FIG. 3 as a single DRAM unit external to the XSSD module 104, it should be understood that the controller 302 may communicate with a plurality of buffer memory units 312 (including one or more DRAM units as described above with reference to FIG. 2), and that the buffer memory units 312 may additionally or alternatively reside within the XSSD module 104.

In some embodiments, the interface(s) between the controller 302 and each of the host system(s) 102, the DSD(s) 106, the NVSSM unit(s) 308, and the buffer memory unit(s) 312 may include one or more interfaces compliant to one or more of the following standards: universal serial bus (USB), IEEE 1394, serial advanced technology attachment (SATA), external SATA (eSATA), parallel advanced technology attachment (PATA), small computer system interface (SCSI), serial attached SCSI (SAS), peripheral component interconnect express (PCIe), and fiber channel (FC). However, any other interface suitable for allowing the controller 302 to communicate with the host system(s) 102, the DSD(s) 106, the NVSSM unit(s) 308, the buffer memory unit(s) 312, or any combination thereof, may be used.

The controller 302 may include a command CPU 318, a translation layer CPU 320, a command memory 322, and a data memory 324. Command data transmitted to the controller 302 can be stored temporarily in the command memory 322 while user data transmitted to the controller 302 can be stored temporarily in the data memory 324. Accordingly, the command memory 322 and the data memory 324 are effectively buffer memory units, or intermediate buffer memory units (i.e., buffer memory units disposed between the buffer memory unit 312 and the CPUs 318, 320), used to temporarily store data transmitted during read and write operations pending execution by either the command CPU 318 or the translation layer CPU 320 or both.

In accordance with some embodiments, the command CPU 318 can be configured to receive read and write requests and allocate user data associated with the requests among the host system(s) 102, the DSD(s) 106, the NVSSM unit(s) 308, and the buffer memory unit(s) 312. The translation layer CPU 320 may be configured to process a software layer that manages read and write access to the NVSSM unit(s) 308. The translation layer CPU 320 or protocol processor can be a flash translation layer (FTL) CPU that translates data allocated to the NAND flash memory such that the allocated data is readable by the NAND flash memory.

Some or all of the components shown in FIGS. 2-3 may be built into a single processor or controller chip and can be configured, via firmware or circuitry, to perform the functions and operations discussed herein for the XSSD module 104 and systems 200, 300.

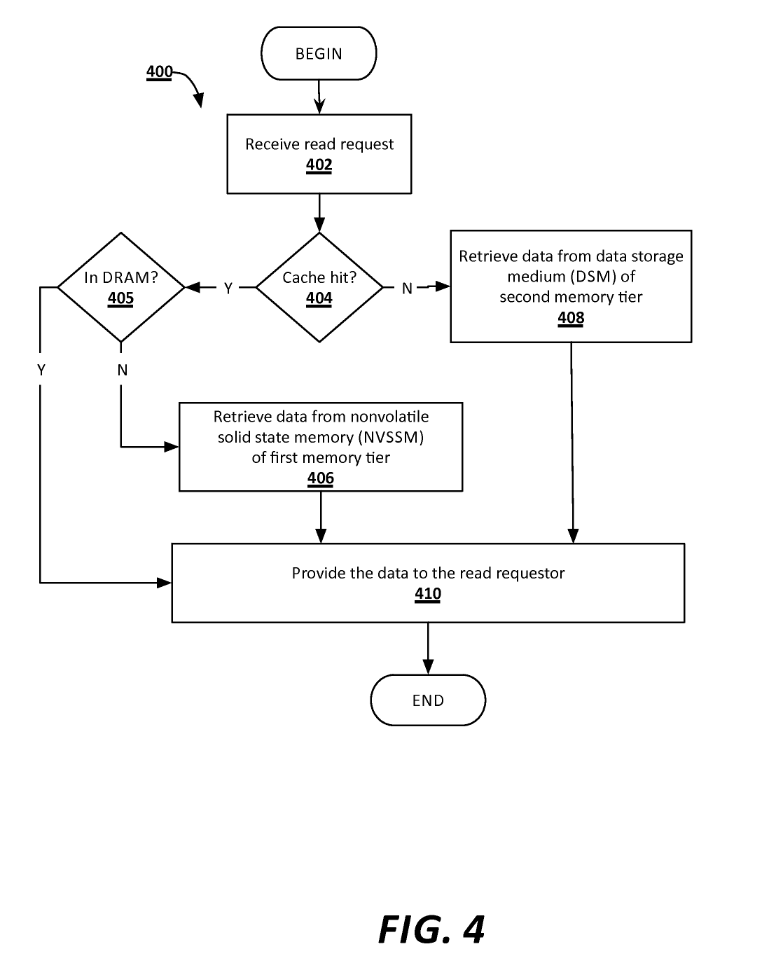

FIG. 4 shows a flowchart of an illustrative embodiment of a method 400 for implementing tiered storage architecture. In describing embodiments of the method 400 illustrated by FIG. 4, reference will also be made to FIGS. 1-3 in order to clarify certain aspects of the method 400.

At block 402, the XSSD module 104 receives a read request. For example, the host system 102 may transmit a read request to the XSSD module 104. However, the read request can originate from any device or system to which the XSSD module 104 is communicatively coupled.

If, at block 404, the XSSD module 104 determines that the read request is a cache hit (i.e., the data requested is stored in cache at the time of the request), then the XSSD module 104 determines if the requested data is cached in DRAM (or SRAM), at block 405. If the requested data is cached in DRAM, then the XSSD module 104 retrieves the data from the DRAM and provides the data to the read requestor (i.e., the device or system that initiated the read request), at block 410. If the requested data is not cached in DRAM, then the XSSD module 104 retrieves the data from a nonvolatile solid state memory (NVSSM) of the first memory tier, at block 406, and provides the data to the read requestor, at block 410.

If, however, at block 404, the XSSD module 104 determines that the read request is not a cache hit, then the XSSD module 104 retrieves the data from a data storage device/medium of a second memory tier, at block 408, and provides the data to the read requestor, at block 410.

As used herein, the term “first memory tier” is used to distinguish a memory tier that includes a NVSSM used as cache from a “second memory tier” that includes a nonvolatile memory used as permanent storage. The terms “first memory tier” and “second memory tier”, however, are neither intended to limit the embodiments of the present disclosure to two memory tiers, nor are they intended to preclude one or more memory tiers before, between, or after the first memory tier and the second memory tier. The flash memory 214, 308 of FIGS. 2-3 illustrate the NVSSM included in the first memory tier of some embodiments. The data storage device/medium (DSD/DSM) 106 of FIG. 3 illustrates the nonvolatile memory included in the second memory tier of some embodiments.

In some embodiments, the XSSD module 104 determines whether the requested data meets either or both of cache criteria and permanent storage criteria, respectively. If the XSSD module 104 determines that the data satisfies its cache criteria, then the data is written to the NVSSM of the first memory tier if not yet stored therein. If the XSSD module 104 determines that the data satisfies its permanent storage criteria, then the data is written to the DSD/DSM that includes the nonvolatile memory of the second memory tier if not yet stored therein. In some embodiments the cache criteria, the permanent storage criteria, or both, may be predetermined based on one or more parameters. However, in some embodiments, the cache criteria, the parameters for permanent storage criteria, or both, can be determined or updated on-the-fly by the XSSD module 104. Parameters on which the cache criteria, the permanent storage criteria, or both, can be based includes, but is not limited to: age (timing), capacity (% full), power event (e.g., shutdown), idle time detected, or parameters, or any combination thereof.

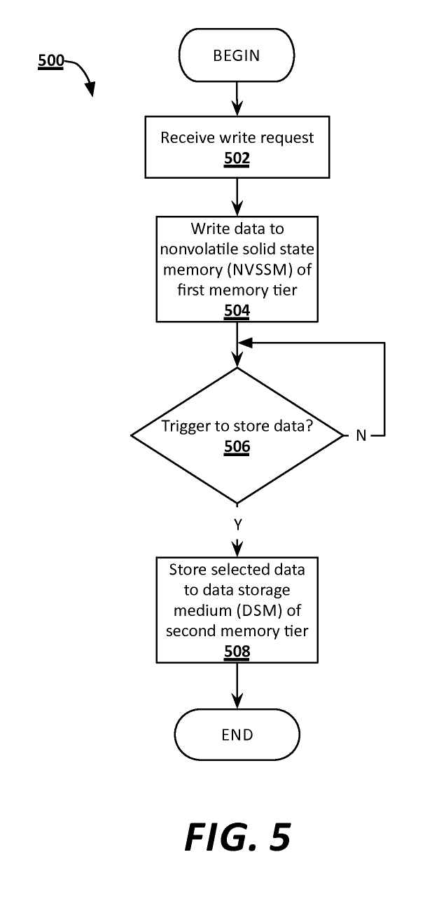

FIG. 5 shows a flowchart of another illustrative embodiment of a method 500 for implementing a tiered storage architecture. In describing embodiments of the method 500 illustrated by FIG. 5, reference will also be made to FIGS. 1-3 in order to clarify certain aspects of the method 500.

At block 502, the XSSD module 104 may receive a write request. For example, the host system 102 may transmit a write request to the XSSD module 104. However, the write request can originate from any device or system to which the XSSD module 104 is communicatively coupled. In some embodiments, the write request may comprise command data and user data that are buffered in volatile memory.

On certain embodiments of the method 500, the XSSD module 104 can write the selected data (i.e., the data to be written as a result of the write request received) to a nonvolatile solid state memory (NVSSM) of the first memory tier, at block 504. Thus, all selected data can be cached to the NVSSM of the first memory tier before it pushes any of the selected data elsewhere.

In certain embodiments, all data passing through the XSSD module 104 may be stored to the NVSSM. For example, all writes can be directed to NVSSM after a threshold time in a cache buffer, which may be a volatile random access memory. When a cache is flushed to NVSSM after the threshold time (or based on another trigger), a minimum amount of write data may be needed, such as equal to a page of flash memory. Further, reads received by the XSSD module 104 may be stored to the NVSSM. In some examples, when data from a read command is stored to the XSSD module 104, at least items may be stored in the NVSSM. First, the actual data requested by a host may be stored and, second, additional Read Look Ahead data may be stored in the NVSSM. For example if the host 102 were to ask for data from logical block address (LBA) 100 and it is not already in the NVSSM, the XSSD module 104 would retrieve the data from the DSD 106 and then return the data from LBA 100 to the host 102. The XSSD module 104 would also store the data from LBA 100 in the NVSSM for future reads, and would also store additional Read Look Ahead data from LBA 101 in case a subsequent request from the host 102 is for LBA 101. Either the XSSD module 104 or the DSD 106 can initiate a read for Read Look Ahead data, which may then be stored in the NVSSM of the XSSD module 104.

At block 506, the XSSD module 104 may determine whether a permanent storage trigger event has occurred, or whether one or more permanent storage criteria are satisfied, or a combination thereof, with respect to any or all of the selected data. If yes, then the XSSD module 104 moves at least a subset of the selected data to the non-volatile memory of the second memory tier, at block 508. The permanent storage trigger event, the permanent storage criteria, or a combination thereof, may be determined based on one or more parameters, such as: age (timing), capacity (% full), power event (e.g., shutdown), idle time detected, other parameters, or any combination thereof

Although FIG. 5 shows the method 500 as caching all selected data to the NVSSM of the first memory tier before it pushes any of the selected data elsewhere, certain embodiments may involve caching only data that meets a predetermined or on-the-fly-determined cache criteria, such as, for example, the cache criteria described above with reference to FIG. 4.

In some embodiments, with such implementations of the apparatus and methods described above with respect to FIGS. 1-5, a hybrid data storage system can be implemented with little or no modification of a host system or a data storage device [e.g., a hard disc drive (HDD)]. Further, the XSSD module 104 may selectively allocate storage space among the multiple devices to be used as nonvolatile cache or to be used as addressable storage space. In some examples, a nonvolatile solid state memory (NVSSM) may be used as a nonvolatile cache, for incoming and outgoing data or for data pinned to cache for faster read access times than from a HDD, whereas the HDD may be used for permanent storage. In certain embodiments, the total capacity of storage reported to a host system may be the capacity of the NVSSM in addition to the capacity of the HDD. Further, in some embodiments, the multiple storage devices/mediums may serve as backup to one or the other; for instance, the HDD may be a backup for the NVSSM or vice-versa.

The XSSD module 104 may be integrated, at least in part, on a host system such that data can be transmitted among the host system, the first memory tier, and the second memory tier. Additionally or alternatively, the XSSD module 104 may be integrated, at least in part, on a data storage device that includes the nonvolatile memory of the second memory tier such that data can be transmitted among the host system, the first memory tier, and the second memory tier. Additionally or alternatively, the XSSD module 104 may be integrated, at least in part, on a bridge adapter configured to allow the XSSD module 104 to be coupled to a host system and a data storage device that includes the nonvolatile memory of the second memory tier such that data can be transmitted among the host system, the first memory tier, and the second memory tier.

In accordance with various embodiments, the methods described herein may be implemented as one or more software programs running on a computer processor or controller, such as the controller 206. In accordance with another embodiment, the methods described herein may be implemented as one or more software programs running on a computing device, such as a personal computer that is using a disc drive. Dedicated hardware implementations including, but not limited to, application specific integrated circuits, programmable logic arrays, and other hardware devices can likewise be constructed to implement the methods described herein. Further, the methods described herein may be implemented as a computer readable medium including instructions that when executed cause a processor to perform the methods.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the above embodiments, and other embodiments not specifically described herein, will be apparent to those of skill in the art upon reviewing the description. Additionally, the illustrations are merely representational and may not be drawn to scale. Certain proportions within the illustrations may be exaggerated, while other proportions may be reduced. Accordingly, the disclosure and the figures are to be regarded as illustrative and not restrictive.

What is claimed is:

1. An apparatus comprising:
a control circuit configured to allocate data among at least a first memory tier and a second memory tier, the first memory tier including a nonvolatile solid state memory and the second memory tier including another nonvolatile memory;
a host interface configured to communicate between the control circuit and a host device;
a data storage device interface configured to communicate between the control circuit and a data storage device that includes the second memory tier, the data storage device interface mimicking the host interface such that the data storage device interfaces with the apparatus as if the data storage device were interfacing directly with the host device; and
the control circuit is further configured to manage transfer of data to the host device, the first memory tier, and the second memory tier.

2. The apparatus of claim 1 further comprising the control circuit is integrated on the host device such that data can be transmitted among the host device, the first memory tier, and the second memory tier.

3. The apparatus of claim 1 further comprising the control circuit is integrated on the data storage device that includes the nonvolatile memory of the second memory tier such that data can be transmitted among the host device, the first memory tier, and the second memory tier.

4. The apparatus of claim 1 is a separately removable hardware device disconnectable from the host interface and the data storage device interface, the apparatus including the nonvolatile solid state memory configured as a buffer.

5. The apparatus of claim 4 further comprising a nonvolatile solid state memory protocol processor configured to, when data is allocated to the nonvolatile solid state memory, implement a protocol translation layer that translates the allocated data such that the allocated data is in a format readable by the nonvolatile solid state memory.

6. The apparatus of claim 5 further comprising:
a buffer manager configured to communicate with the control circuit and allocate data among one or more volatile memory units configured as a buffer; and
a first-in-first-out (FIFO) memory unit configured to store data received from the buffer manager and transmit the received data to the nonvolatile solid state memory protocol processor.

7. The apparatus of claim 5, the nonvolatile solid state memory is Flash memory and the nonvolatile memory is a magnetic data storage medium, the apparatus further comprising a buffer manager configured to communicate with the control circuit and allocate data among one or more volatile memory units configured as a buffer.

8. The apparatus of claim 5 further comprising:
the first memory tier; and
an output from the nonvolatile solid state memory protocol processor, the output configured to couple the nonvolatile solid state memory protocol processor to the nonvolatile solid state memory.

9. The apparatus of claim 5 further comprising a nonvolatile solid state memory interface configured to communicate between the nonvolatile solid state memory protocol processor and the nonvolatile solid state memory, the first memory tier is integrated on one or more separately removable hardware devices disconnectable from the apparatus.

10. The apparatus of claim 1 further comprising:
the control circuit is further configured to:
cache data in the nonvolatile solid state memory of the first memory tier for data that meets one or more cache criteria; and
store data in the nonvolatile memory of the second tier at least in part as storage space for data that meets one or more storage criteria for the second memory tier.

11. The apparatus of claim 10 further comprising the one or more cache criteria and the one or more storage criteria are determined based on one or more parameters selected from a group consisting of: timing, capacity, power event, and idle time.

12. An apparatus comprising:
a control circuit configured to allocate data among at least a first memory tier and a second memory tier, the first memory tier including a nonvolatile solid state memory and the second memory tier including another nonvolatile memory;
an initiator interface configured to communicate between the control circuit and an initiator device;
a target interface configured to communicate between the control circuit and a target device;
at least one of the initiator interface and the target interface replicates a host interface such that a data storage device including the nonvolatile memory of the second memory tier interfaces with the apparatus as if it were interfacing with a host device; and
the control circuit is further configured to manage transfer of data to the host device, the first memory tier, and the second memory tier.

13. The apparatus of claim 12 further comprising the initiator interface and the target interface are each compliant to an interface standard.

14. The apparatus of claim 12 further comprising the control circuit is configured to cache all data to the nonvolatile solid state memory of the first memory tier before storing the data to the nonvolatile memory of the second memory tier.

15. The apparatus of claim 14 further comprising a buffer manager configured to communicate with the control circuit and allocate data among one or more volatile memory units configured as a buffer.

16. The apparatus of claim 15 further comprising a nonvolatile solid state memory protocol processor configured to, when data is allocated to the nonvolatile solid state memory, implement a protocol translation layer that translates the allocated data such that the allocated data is in a format readable by the nonvolatile solid state memory.

17. The apparatus of claim 16 further comprising:
a nonvolatile solid state memory interface configured to communicate between the nonvolatile solid state memory protocol processor and the nonvolatile solid state memory; and
a volatile memory interface configured to communicate between the buffer manager and one or more volatile memory units configured as a buffer.

18. An apparatus comprising:
a control circuit configured to:
receive, from a host system, a request to write selected data;
cache the selected data to a first nonvolatile solid state memory; and
store at least a subset of the selected data to a second nonvolatile memory based on a trigger event;
a host interface configured to communicate between the control circuit and the host system; and
a data storage interface configured to communicate between the control circuit and the second nonvolatile memory, the data storage interface mimicking the host interface such that the data storage device interfaces with the apparatus as if the data storage device were interfacing directly with the host system.

19. The apparatus of claim 18, the selected data is translated by a protocol processor before it is cached to the first nonvolatile solid state memory such that the selected data is in a format readable by the first nonvolatile solid state memory.

20. The apparatus of claim 19 further comprising a nonvolatile solid state memory interface configured to communicate between the protocol processor and the first nonvolatile solid state memory.
